(19) United States
(12) Patent Application Publication
(10) Pub. No.: US 2025/0170990 A1
(43) Pub. Date: May 29, 2025

(54) WINDSHIELD-WIPING APPARATUS, IN PARTICULAR FOR A MOTOR VEHICLE

(71) Applicant: Robert Bosch GmbH, Stuttgart (DE)

(72) Inventors: Manuel Hans Reith, Lauf (DE); Lukas Leitz, Kuppenheim (DE); Michael Kruse, Sinzheim (DE)

(21) Appl. No.: 18/953,215

(22) Filed: Nov. 20, 2024

(30) Foreign Application Priority Data
Nov. 27, 2023 (DE) 10 2023 211 781.9

(51) Int. Cl. B60S 1/54; B60S 1/52

(52) U.S. Cl. CPC B60S 1/542; B60S 1/524; B60S 1/546

(57) ABSTRACT

A windshield-wiping apparatus (10) is proposed, in particular for a motor vehicle, comprising a wiping element (18) that can be moved over a windshield (12) to be wiped. According to the present invention, a compressed gas generator (14) generating compressed gas is provided, and the wiping element (18) is configured so as to pass over the windshield (12) in a contactless manner.

### BACKGROUND

The invention relates to a windshield-wiping apparatus, in particular for a motor vehicle.

Windshield-wiping apparatuses having a wiping element are already known.

For example, DE 102 50 322 A1 discloses a windshield-wiping apparatus comprising a wiping element.

### SUMMARY

The windshield-wiping apparatus according to the invention, having the features of the main claim, has the advantage that a compressed gas generator generating the compressed gas is provided, and the wiping element is configured so as to pass over the windshield in a contactless manner. A good wiping result is achieved as a result, wherein the wiping element does not wear out.

The measures listed in the dependent claims enable advantageous further developments and improvements of the features specified in the main claim.

Advantageously, a particularly good wiping result is achieved when the wiping element comprises a plurality of nozzles for ejecting the compressed gas.

In this case, it is particularly advantageous for the nozzles to be arranged regularly along the longitudinal extension of the wiping element. This is particularly easy to manufacture and delivers a good wiping result.

It is particularly advantageous when the density of the nozzles in the region of a sensor device is higher along the longitudinal extension than in the remaining region of the wiping element, because a particularly good wiping result is then achieved in the region of the sensor device.

An advantageously good wiping result is achieved by having the nozzles arranged at an angle to the windshield in relation to a perpendicular.

Compressed air is used as the compressed gas in a simple, inexpensive, and therefore advantageous manner.

A particularly good cleaning effect is advantageously characterized in that a cleaning agent is added to the compressed gas.

### BRIEF DESCRIPTION OF THE DRAWINGS

One exemplary embodiment of the invention is shown in the drawings and explained in further detail in the following description. Shown are:

FIG. 1 a windshield-wiping apparatus according to the invention in a schematic representation,

FIG. 2 a cross-section through a wiping element of a windshield-wiping apparatus according to the invention in a schematic representation, and

FIG. 3 a schematic side view of a wiping element.

### DETAILED DESCRIPTION

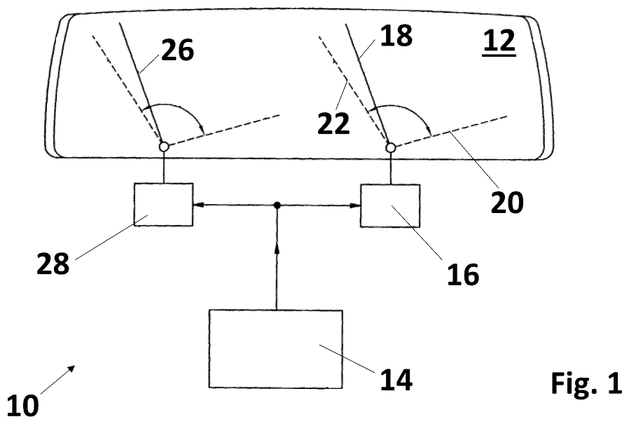

FIG. 1 shows a schematic illustration of a windshield-wiping apparatus 10 according to the invention. It wipes a windshield 12, in particular a windshield of a motor vehicle.

The windshield-wiping apparatus 10 according to the invention comprises a compressed gas generator 14, which is configured as a compressor for air.

In addition, the windshield-wiping apparatus 10 according to the invention comprises a drive unit 16, as well as a wiping element 18 that is guided over the windshield 12 during operation.

The wiping element 18 alternates back and forth between a lower reverse position 20 and an upper reverse position 22. However, in one variation of the invention, the wiping element 18 can also be guided linearly over the windshield 12.

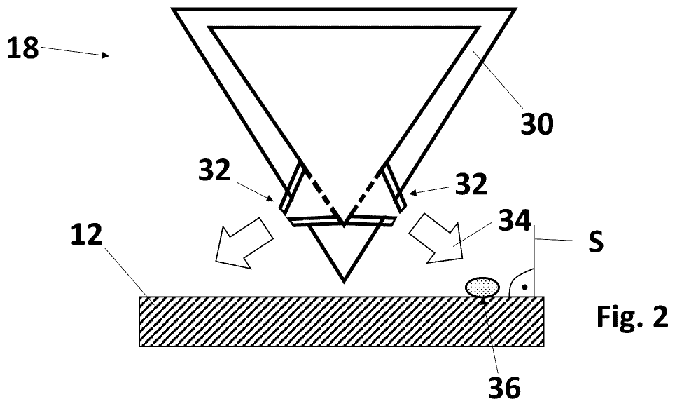

The wiping element 18 is also connected to the compressed gas generator 14. The compressed gas generator 14 generates compressed air that is directed to the wiping element 18 via corresponding hose lines and from there exits out of nozzles 24 (FIG. 2).

As shown here, a further wiping element 26 can also be provided, which is also connected to the compressed gas generator 14. The further wiping element 26 can be set into motion by a further drive unit 28 or can also be connected to the drive unit 16 so that it is set into motion by the latter.

FIG. 2 shows a cross-section through a wiping element 18 of a windshield-wiping apparatus 10 according to the invention, as well as a windshield 12 in a schematic representation.

The wiping element 18 comprises a guide bar 30 that serves as a passage for the compressed air of the compressed gas generator 14. A plurality of nozzles 32 are arranged on the guide bar 30, which direct the compressed gas or compressed air towards the windshield 12.

The nozzles 32 are arranged at an angle in relation to an imaginary perpendicular line S, so that the flow of compressed air (arrow 34) flowing out of nozzles 32 also strikes against the windshield 12 and blows away any existing rain and dirt particles 36.

The guide bar 30 is guided at a slight distance over the windshield 12 and does not contact it. The guide bar 30 is therefore guided in a contactless manner over the windshield 12.

As shown herein, the nozzles 32 can be arranged respectively opposite one another.

In a simple configuration, the guide bar 30 is made from plastic. The valves 32 can also be made from plastic and can be provided integrally with the guide bar 30, for example. However, in one variation of the invention, the valves 32 can also be made from metal.

In addition to the compressed air, a cleaning agent can also be supplied. For example, this can be mixed with the compressed air in a mist-like manner.

However, in one variation of the invention, a cleaning liquid, which is also guided to the nozzles 32 through the guide bar 30, can also be applied briefly to the windshield 12 through the nozzles 32.

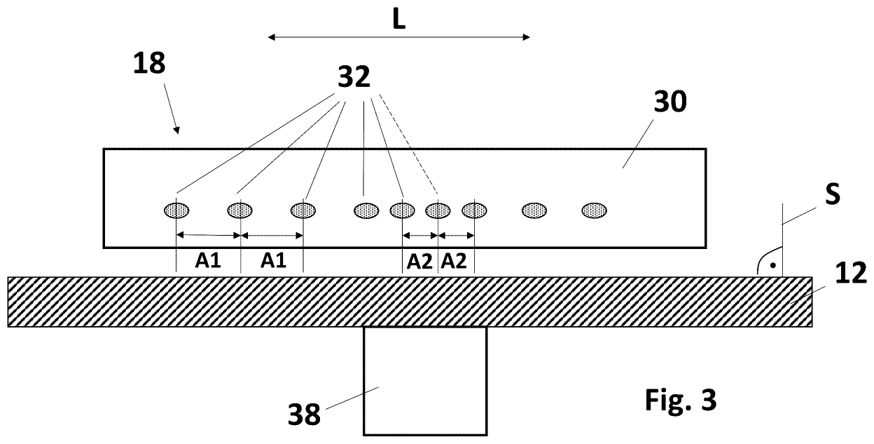

In FIG. 3, a wiping element 18 according to the invention is shown in a schematic side view.

The guide bar 30 bears the nozzles 32. Here, an in particular optical sensor device 38 is also arranged on the windshield 12. It is configured as a camera that observes the surroundings in front of the vehicle. In one variation, a LIDAR camera can also be used as a sensor device 38 herein.

The individual nozzles 32 each have a normal distance A1 along the longitudinal extension L. Adjacent nozzles 32 are thus arranged equidistantly. In the region of the sensor device 38, the nozzles 32 along the longitudinal extension L have a nozzle distance A2 that is less than the normal distance A1. As a result, the density of the nozzles 32 is increased, thereby achieving in particular an improved cleaning performance in the region of the sensor device 38. A smaller distance is therefore provided between the individual nozzles 32 in the region of the guide bar 30 that passes over the sensor device 38, because the nozzle distance A2 is smaller than the normal distance A1.

The nozzles 32 can only be seen from one side in this view. The nozzles 32 can also be arranged only on one side or, as shown in FIG. 2, on both sides of the guide bar 30.

The nozzles 32 can be arranged offset on both sides, such that one nozzle 32 is arranged on one side between two nozzles 32 on the other side. In a further variation, the nozzles 32 can generally be arranged on one side, but, in the region of the sensor device 38, i.e. in the region of the guide bar 30 that passes over the sensor device 38, can be arranged on two sides.

In addition, guide elements, in particular sliding or rolling elements, in particular in the region of the ends in relation to the longitudinal extension L, can be arranged on the guide rail 30, which ensure the distance of the guide rail 30 from the windshield 12.

1. A windshield-wiping apparatus (10) comprising a wiping element (18) that can be moved over a windshield (12) to be wiped, wherein a compressed gas generator (14) generating compressed gas is provided, and the wiping element (18) is configured so as to pass over the windshield (12) in a contactless manner.

2. The windshield-wiping apparatus (10) according to claim 1, wherein the wiping element (18) comprises a plurality of nozzles (32) for ejecting the compressed gas.

3. The windshield-wiping apparatus (10) according to claim 2, wherein the nozzles (32) are arranged regularly along the longitudinal extension (L) of the wiping element (18).

4. The windshield-wiping apparatus (10) according to claim 2, wherein, along the longitudinal extension (L), the density of the nozzles (32) in the region of a sensor device (38) is higher than in the remaining region of the wiping element (18).

5. The windshield-wiping apparatus (10) according to claim 2, wherein the nozzles (32) are arranged at an angle to the windshield (12) in relation to a perpendicular(S).

6. The windshield-wiping apparatus (10) according to claim 1, wherein the compressed gas is compressed air.

7. The windshield-wiping apparatus (10) according to claim 1, wherein cleaning agent or cleaning liquid is added to the compressed gas.
